(19) United States
(12) Patent Application Publication
(10) Pub. No.: US 2004/0091248 A1
(43) Pub. Date: May 13, 2004

(54) Method and apparatus for recording video signal

(75) Inventors: Kenichiro Tada, Tokorozawa-shi (JP); Katsumi Kimura, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/691,709

(22) Filed: Oct. 24, 2003

(30) Foreign Application Priority Data
Oct. 25, 2002 (JP) P2002-310626

(51) Int. Cl. H04N 5/76

(52) U.S. Cl. 386/95; 386/111

(57) ABSTRACT

An apparatus is provided for recording a video signal into a recording medium. The video signal is included in a stream signal. The apparatus comprises a detector detecting display time information included in the stream signal and a decoder decoding the stream signal to output the video signal, and a scaler changing a display scale of the video signal outputted by the decoder in response to a desired size of a thumbnail. A switch is connected to an output of the scaler, while a memory is connected via the switch to the scaler. The apparatus further comprises a unit acquiring the display time information detected by the detector in response to an acquisition command for the thumbnail, and a controller controlling the switch so that the video signal outputted from the scaler is stored in the memory. The outputted video signal corresponds to the acquired display time information.

### BACKGROUND OF THE INVENTION

1. The Field of the Invention

The present invention relates to a method and apparatus for recording broadcasted information into a recording medium in order to acquire a thumbnail signal, the broadcasted information being delivered via a network or a broadcasting system.

2. Related Art

In general, information to be broadcasted is divided into a plurality of packets in each of which a predetermined amount of information is packed.

For handing such packets, a conventional technique has focused on convenience in reproducing the information to be broadcasted. That is, when information to be broadcasted is received by a receiver, a reception time is attached packet by packet to the reception information for its recording and preservation. Whenever it is required to reproduce the information, the reception time is used to identify, packet by packet, which information should be broadcasted.

Under such a circumstance, a recent-frequently used way is to dynamically compress video information included in the information to be broadcasted, before the information is delivered.

On the other hand, acquiring thumbnail information involves a reduced screen and requires that the TV screen is posed so that a frame buffer is directly accessed. In this case, the decoding should be stopped temporarily. That is, while viewing the TV screen on which a program is represented by digital broadcasting, a user is unable to process information about thumbnails. Thus, program contents should temporarily be recorded into a recording medium and be reproduced, if a user desires to have thumbnail information in relation to the program contents.

### SUMMARY OF THE INVENTION

An object of the present invention is to provide, with due consideration to the drawback of the above conventional technique, a video signal recording apparatus and a video signal recording method, which are able to allow a user to have a thumbnail screen of an arbitrarily specified size, without posing the screen, while the user views a broadcasted program on the screen.

In order to accomplish the above object, the present invention provides, as one aspect thereof, an apparatus for recording a video signal into a recording medium, the video signal being included in a stream signal, the apparatus comprising: a detector configured to detect display time information included in the stream signal; a decoder configured to decode the stream signal to output the video signal; a scaler configured to change a display scale of the video signal outputted by the decoder in response to a desired size of a thumbnail; a switch connected to an output of the scaler; a memory connected via the switch to the scaler; a display time information acquisition unit configured to acquire the display time information detected by the detector in response to an acquisition command for the thumbnail; and a controller configured to control a switching operation of the switch so that the video signal outputted from the scaler is stored in the memory, the outputted video signal corresponding to the display time information acquired by the display time information acquisition unit.

Preferably, the memory is configured to memorize the video signal sectioned by a sync signal and outputted from the scaler.

As another aspect of the present invention, there is provided a method for recording a video signal into a recording medium, the video signal being included in a stream signal, the method comprising the steps of: detecting display time information included in the stream signal; decoding the stream-signal to output the video signal; changing a display scale of the outputted video signal in response to a desired size of a thumbnail; acquiring the detected display time information in response to an acquisition command for the thumbnail; and controlling a flow of the video signal of which display scale is changed is stored in a memory, the stored video signal corresponding to the acquired display time information.

Still, as another aspect of the present invention, there is provided a computer-readable program for recording a video signal into a recording medium, the video signal being included in a stream signal, the program allowing a computer to monitor and control the steps of: detecting display time information included in the stream signal; decoding the stream signal to output the video signal; changing a display scale of the outputted video signal in response to a desired size of a thumbnail; acquiring the detected display time information in response to an acquisition command for the thumbnail; and controlling a flow of the video signal of which display scale is changed is stored in a memory, the stored video signal corresponding to the acquired display time information.

### BRIEF DESCRIPTION OF THE DRAWINGS

In the accompanying drawings:

FIG. 1 illustrates a format for recording contents of broadcasted information;

FIG. 2 is a block diagram showing the entire configuration of a video signal recording apparatus according to an embodiment of the present invention;

FIG. 3 illustrates a concept of control timing for the recording according to the embodiment;

FIG. 4 is an illustration of both of the transmission of video data and timing of detecting PTS and decoding video data;

FIG. 5 conceptually illustrates the output of SCD in the present embodiment;

FIG. 6 is a flowchart showing the processing for starting unit recording in the present embodiment;

FIG. 7 is a flowchart showing the processing for acquiring thumbnails in the present embodiment; and

FIG. 8 is a flowchart showing the processing for ending unit recording in the present embodiment.

### DETAILED DESCRIPTION OF THE PREFERRED EMBODIMENT

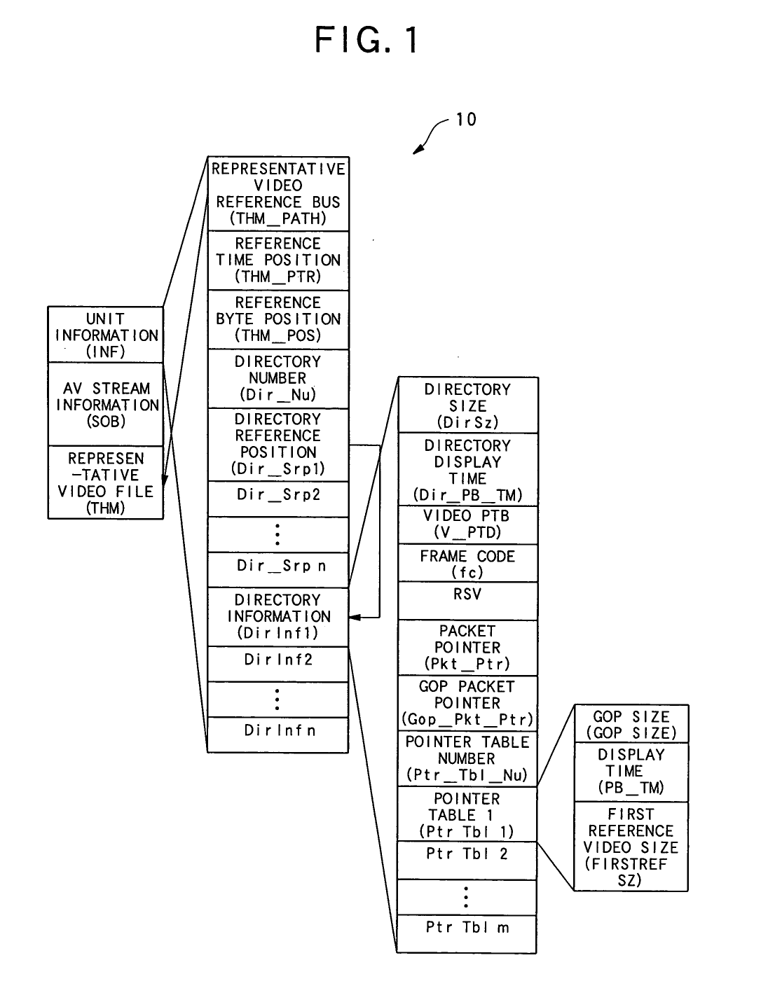

Referring to FIGS. 1 to 8, an embodiment of the present invention will now be described.

The present embodiment is reduced into practice concerning a video signal recording apparatus to which the present invention is applied. Such video signal recording apparatus has the configuration of recording and processing AV (Audio Visual) information delivered through digital broadcasting, which is presented by BS digital broadcasting.

In the following, the AV information is broadcasted based on the Transport Stream standard of the MPEG (Motion Picture Expert Group) 2 standard, which is known as one standard with respect to the compression of motion pictures.

### (1) Example of Recording Format

Prior to a detailed description of the video signal recording apparatus according to the present embodiment, a logical recording format used in recording AV information into a hard disk of the video signal recording apparatus will first be outlined in connection with FIG. 1. The recording format pictorially depicted in FIG. 1, which has a hierarchical structure, shows its state already recorded in the hard disk.

The recording format shown FIG. 1 is shown logically and used for recording AV information into the hard disk. A physical recording format used for the recording is the same as that, which is known, of the hard disk.

Various concepts, which are employed by the recording format in order to efficiently handle both the contents of recorded AV information and their recorded modes, will now be outlined.

First, this recording format uses a concept of “unit,” which is a minimum amount in handling the recorded AV information. That is, the “unit” is defined by a single piece of AV information recorded sequentially in time into the hard disk. For example, in the case of AV information that has been received through BS (Broadcast Satellite) digital broadcasting, a definition is made such that one event handled by the BS digital broadcasting corresponds to one unit.

Secondary, the recording format uses a concept of “directory.” This concept of directory is applied to packets whose identification numbers PIDs are the same, the packets memorizing video information of transport streams acquired by the BS digital broadcasting, for example. Attaching the same packet identification number PID is originated from a broadcaster's intension. Therefore, the directory is a section defined by specifying one unit or part of one unit and by giving the same packet identification number PID to the specified entire unit or partial unit.

Third, in the directory, a concept of “application GOP (Group of Picture) (hereinafter, simply referred to as AP_GOP) is also incorporated in the recording format. The application GOP shows a single section in which GOP provided by the MPEG2 standard is placed for transmission.

A fourth concept is concerned with a thumbnail indicative of a representative image of AV information in each unit. The thumbnail is therefore a still picture recorded as a representative of all AV information in each unit.

Based on the foregoing various concepts, the logical recording format according to the present embodiment will now be described.

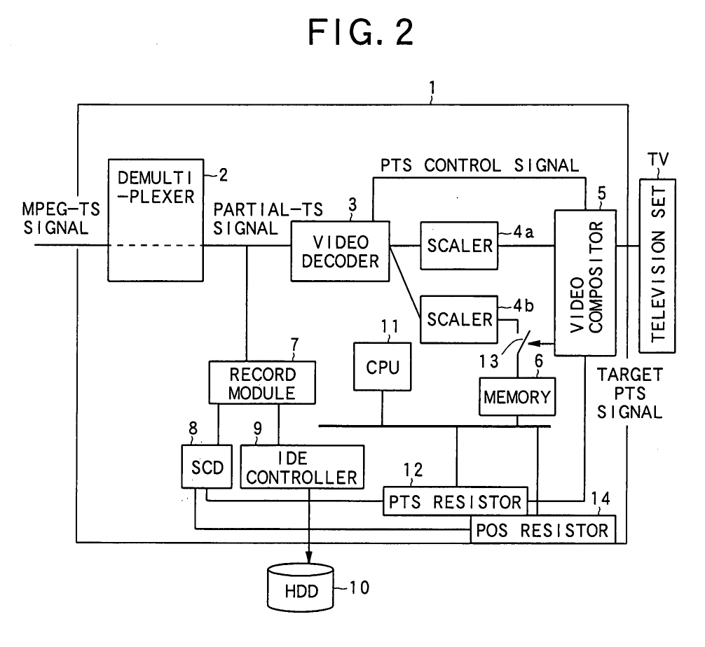

As shown in FIG. 1, once necessary AV information is stored into a hard disk 10 (refer to FIG. 2), there are recorded, in the hard disk 10, unit information (INF) that is administration information corresponding to each unit described above, AV stream information SOB that is AV information itself broadcasted and recorded in the hard disk 10, and a representative video file (THM) that is a thumbnail of each unit.

The unit information INF is composed of, as shown in FIG. 1, a representative video referential path TH_PATH (256 bytes) of which path name pointing to the representative video file (THM) that is a thumbnail of each unit; a reference time position THM_PTR (4 bytes) set to the AV stream information (SOB); a reference byte position or packet number THM_POS (4 bytes) set to the AV stream information (SOB); a directory number Dir_Ns (2 bytes) indicating the number of directories included each unit, each directory being assigned to each packet identification number (hereinafter referred to as PID) showing a packet that carries video information in a transport stream, which is a format during a broadcasting operation of the AV information; a directory reference position Dir_Srp (4 bytes) showing a position of information concerning each directory, the position being counted from the top of the unit information; and directory information DirInf.

Next, the directory information DirInf will now be detailed.

As shown in FIG. 1, the directory information DirInf is composed of a directory size DirSz (4 bytes) showing the number of TS packets included in each directory; a directory display time Dir_PB_TM (4 bytes) indicating a total display time of videos identified by a video PID in the video information included in each directory; a video PID, i.e., V_PID (2 bytes) indicative of an identification number PID to identify packets that carry video information uniquely decided in the directory; a frame code fc (1 byte) showing a reference display frequency of video information; reserve information RSV (1 byte); a packet pointer Pkt_Ptr (4 bytes) showing a position that provides the first recognition of being a TS packet when the directory is recorded, the position being expressed by the number of bytes counted from the top of the directory; a GOP packet pointer GOP_Pkt_Ptr (4 bytes) showing a position that provides the first recognition of being the AP_GOP when the directory is recorded, the position being expressed by the number of packets counted from the end of the Pkt_Ptr, that is, from the position shifted from the directory top by a size of Pkt_Ptr; a pointer table number Ptr_Tbl_Ns (4 bytes) indicating the number of AP_GOPs included in each directory; and a pointer table Ptr_Tbl indicating information in relation to the AP_GOP.

The pointer table Ptr_Tbl will now be detailed about its configuration.

As shown in FIG. 1, the pointer table Ptr_Tbl is composed of a GOP size GOP_SIZE (4 bytes) indicating the number of packets included in each AP_GOP; a PB_TM (2 bytes) indicating a video PID of a directory to which each AP_GOP belongs, that is, indicating the total display time of video information identified by the V_PID; and a first reference video size FIRSTREF_SZ (2 bytes) indicative of the number of packets, which is gained by counting packets from the top of each AP_GOP to a particular packet including the last of the first reference video that exists in the AP_GOP.

In addition, the representative video file THM representing each unit is encoded in a predetermined format in advance, and stored as a file that can be accessed by a user.

### (2) Example of Video Signal Recording Apparatus

The configuration and operations of a video signal recording apparatus for recording AV information will now be described. This apparatus is configured to be adapted to the foregoing recording format.

Referring to FIG. 2, the entire configuration and outlined operations of the video signal recording apparatus 1 will now be described. This apparatus 1 is provided with a CPU to control all the components arranged in the apparatus 1, but FIG. 2 shows only necessary components relating to the control carried out in the present embodiment.

As shown in FIG. 2, the video signal recording apparatus 1 according to the present embodiment has an output terminal directly connected to a television set TV placed outside the apparatus 1 and an input connected to a not-shown digital broadcasting reception circuit receiving digital broadcasting signals through an antenna.

The video signal recording apparatus 1 is provided with a demultiplexer 2, video decoder 3, scalers 4a and 4b serving as scale changing means, video compositor (mixer) 5, memory 6 serving as memory means, recode modular 7, SCD (Start Code Detector) 8 serving as detection means, IDE controller 9, hard disk (HDD) 10 serving as a recording medium, display time information (hereinafter referred to as PTS), CPU 11 serving as acquisition means and control means, PTS register 12, switch 13 serving as switching means, POS register 14, and bus 15.

The operations of the above individual components will now be outlined.

The demultiplexer 2 is configured to extract only packets necessary for the processing carried out in this apparatus 1, from an MPEG-TS signal received from the foregoing digital broadcasting reception circuit. To be specific, this demultiplexer 2 receives digital-broadcasted streams based on the MPEG-TS format and selectively picks up necessary video-signal packets by specifying a packet ID pointing to packets that carry video signals to be decoded. Also the demultiplexer 2 has an additional function of extracting necessary data, such as audio signals, other added data, and data used by the CPU, in response to specifying a PID (i.e., packet identification number) indicating those data. The way of selecting only necessary packets from a bit stream train that has been transmitted on the MPEG-TS mode is called partial-TS technique.

The video decoder 3 is configured to extract a video signal carried by the packets of which PIDs are specified by the CPU 11, from the partial-TS signal outputted from the demultiplexer 2, and decodes the extracted video signal. In the present embodiment, a plurality of video decoders, each functions as stated above, may be placed in the apparatus 1; but for sake of a simplified explanation, only one video decoder 3 is depicted as shown in FIG. 2.

Each of the scalers 4a and 4b has the function of scaling a video decoded by the video decoder 3 to an arbitrary size of video frame. In the present invention, the recording apparatus 1 is provided a plurality of scalers, such as two scalers, as shown in FIG. 2. The scalers 4a and 4b are connected to the output of the video decoder 3 in an appropriate mode. If there are plural video decoders are provided, any one video decoder may have a connection with the scalers. As shown in FIG. 2, the output of one video decoder can electrically be coupled with the inputs of the plural scalers.

The video compositor 5 is configured to mix outputs from the two scalers 4a and 4b with each other at a desired display position, and to provide the mixed output, as a signal to be displayed, to a monitor of the television set TV. This makes it possible to provide a screen such as picture-in-picture screen (PinP).

In addition, this video compositor 5 is configured to respond to control under the CPU 11 so that the compositor makes reference to a value stored by the PTS register 12, while the compositor 5 receives a PTS (display time information) notification from the video decoder 3 to function so as to recognize the PTS for the display screen. Hence, while the screen is displayed responsively to the value stored by the PTS register 12, the video compositor 5 allows the switch 13 to be connected (i.e., the switch 13 is on).

The memory 6 is a storage which is accessed by various components in the apparatus 1. In this embodiment, the memory 6 has the function of memorizing outputs from the scaler 4b and accepting an access from the CPU 11 via the bus 15.

The record module 7 functions so that the partial-TS signal is recorded into for example the HDD 10. In particular, once a setting operation for the record is given, the record module 7 operates to keep recording the partial-TS signal into the HDD 10 under the control of the IDE controller 9, before an explicit recording-stop command is given. Hence, the record module 7 is able to serve as a data buffering device for the record.

The SCD 8 is in charge of monitoring an ES (Elementary Stream) of video signal carried by the packets of which PIDs are specified by the CPU 11 among the partial-TS signal delivered to the record module 7 and checking a start code using the monitored result. Specifically, the SCD 8 is configured to hold an SHC (Sequence Header Code), a Picture Start Code, and values of the PTSs related thereto. In addition, the SCD 8 also holds information indicating that those values are held at which position in the bit stream train stored in the recode module 7. The held values are made reference by the CPU 11 and stored into the HDD 10 or others.

Once a setting operation for the check is given, the SCD 8 keeps continuing the check until an explicit recording-stop command is given. When a control signal is given by the CPU 11, the SCD 8 is capable of holding, in the PTS resister 12, a PTS value that first detects after the issuance of the control signal and also holding, in the POS register 14, byte positions of packets holding the PTS value in the bit stream train transmitted after the record start.

The IDE controller 9 has an IDE interface function which is responsible for writing and reading data into and from the HDD 10, for example.

The HDD 10 enables bit stream trains coming from the recode module 7 to be recorded for storage therein and data from the CPU 11 to be stored therein. On demand, the CPU11 responds to allow the stored data to be read out.

The PTS register 12 receives from the SCD 8 the value of the PTS to permit the video compositor 5 to control the switch 13 and holds the received value therein.

In the present embodiment, the switch 13 can be switched on or off in compliance to an output from the video compositor 5, if it is desired that an output from the scaler 4b be memorized in the memory 6.

The POS register 14 operates based on an output signal from the SCD 8 so that the position of a byte corresponding to the PTS is held by the PTS register 12.

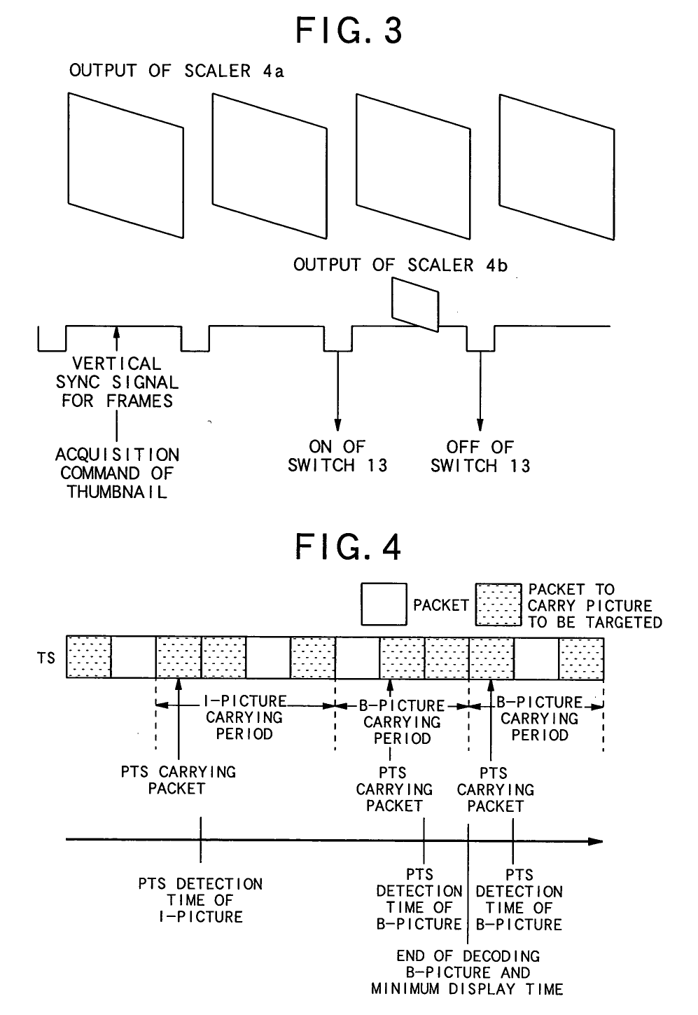

The video signal recording apparatus 1 constructed as explained in above is responsive to a thumbnail acquisition command coming from a not-shown remote controller or voluntarily generated by the CPU 11. When such command is issued, the scaler 4b, video compositor 5, PTS register 12, and switch 13 is controlled depending on timing conceptually shown in FIG. 3.

### 1) Normal Viewing State of Videos

In the normal viewing state of videos, as shown in FIG. 3, decoded outputs from the video decoder 3 are sent in sequence to the video compositor 5 via the scaler 4a, whereby the video compositor 5 enables the television set TV to display such outputs thereon.

### 2) Timing of Thumbnail Acquisition

In cases where a thumbnail acquisition command is issued in the normal viewing state, the CPU 11 operates to execute the following operations in sequence.

(Step 1) First, a connection between the video decoder 3 and the scaler 4b is established, so that the video decoder 3 also supplies the scaler 4b with its output, that is, decoded video signals.

(Step 2) A scaling value showing a desired size of thumbnail to be acquired is given to the scaler 4b, thus the scaler 4b providing a video of which size is desired.

(Step 3) Then, an area in which the video to be acquired is stored is secured in the memory 6. This secured area is given notice to the scaler 4b.

(Step 4) When the above preparation steps have been completed, the switch 13 is connected as shown in FIG. 3 in sync with a vertical sync signal (VSYNC) used by the video compositor 5 for its output. Hence, the video data is transferred from the scaler 4b to the secured area in the memory 6. Concurrently, the PTS of the transferred video data is kept by the PTS register 12.

(Step 5) Then the switch 13 is switched off synchronously with the vertical sync signal of the next frame to the above data transfer. Thus, no more overwrite is carried out onto the area secured in the memory 6.

(Step 6) After this, since it is not required to make the scaler 4b work; the scaler 4b is disconnected from the video decoder 3.

Concerning the TS subjected to the above operations, the transmission of video data and the timing of PTS detection and video data decoding are pictorially shown in FIG. 4. As shown in FIG. 4, configuration setting for the above thumbnail acquisition should be completed in a period of time from the detection of a PTS to the decoding and display of corresponding video data. It is also possible that the video decoder 3 or video compositor 5 has a sufficient delay line in order to secure the configuration setting.

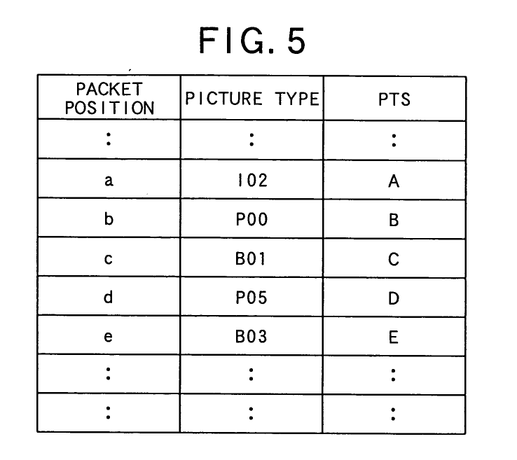

In FIG. 4, the SCD 8 detects a PTS from video data carried in the TS, and a PTS detection time of an I-picture and a PTS detection time of a B-picture correspond to time instants at which the SCD 8 detects the PTS of the I-picture and the PTS of the B-picture, respectively. In addition, the outputs of the SCD 8 are set as shown in FIG. 5, in which, for example, a packet poison of “a-th byte” provides a “102 picture” of which PTS is “A,” a packet poison of “b-th byte” provides a “BOO picture” of which PTS is “B,” and so on.

After completing the recording operation of the stream, the values at the PTS register 12, which have been held as described above, and the data in the area secured in the memory 6 are recorded under the control of the CPU 11, of which steps are as follows.

(Step 1) The PTSs held by the PTS register 12 are set as being reference time positions THM_PTR in AV stream information (SOB).

(Step 2) Using outputs from the SCD 8, packet positions THM_POS corresponding to PTSs held by the PTS register 12 are obtained.

(Step 3) The CPU 11 has access to the video data in the area secured in the memory 6, and encodes the data in conformity with a predetermined video format.

(Step 4) The encoded data is stored in the HDD 10 as a user's accessible file. In this storing operation, a file's path name THM_PATH is produced.

(Step 5) Using the file's path name THM_PATH, reference time position THM_PTR, and packet position THM_POS, unit information INF is produced.

In this way, the present embodiment provides the video signal recording apparatus 1, in which the one video decoder 3 delivers signals to two scalers 4a and 4b. The outputs from the scalers 4a and 4b are partially routed to the memory 6 which is placed separately from the video compositor 5. The function of the scalar 4b is utilized as a function for producing a thumbnail. To be specific, when an output (decoded video signals) from the scalar 4b is sent to the memory 6, the switch 13, which operates synchronously with the sync signal (signal for the frame and field) required by the video output system, is used. Only a bit stream composing a video sectioned by the sync signal is stored in the memory 6. Concurrently, the PTS of the video sectioned by the sync signal is stored in the PTS register 12, so that the video's PTS and the video in the memory 6 are mutually matched through the POS register 14 that is responsive to the SCD 8.

### (A) Processing for Start of Unit Recording

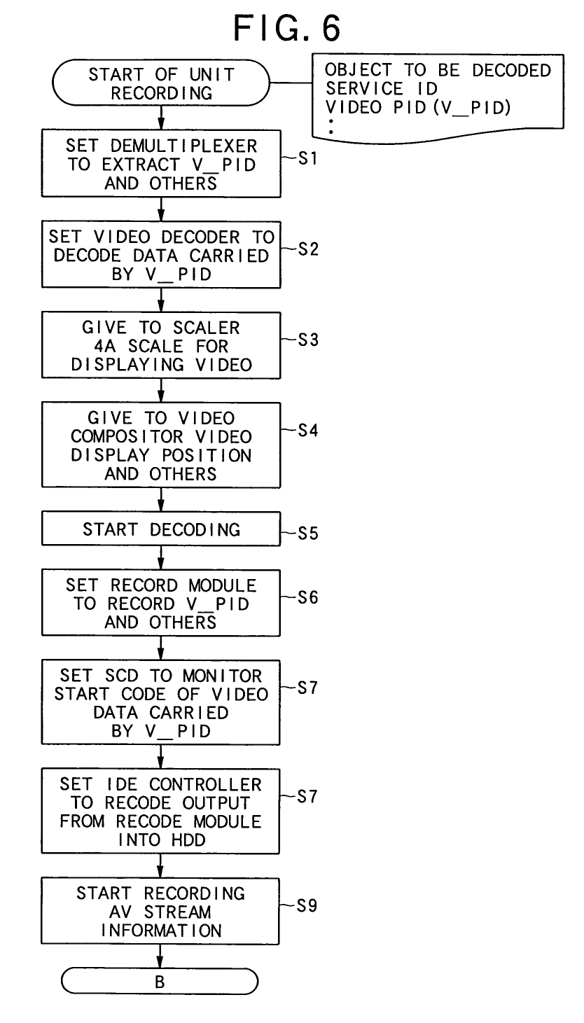

Referring to FIG. 6, the processing for start recording unit information INF, which is executed by the CPU 11, will now be explained.

Objects to be decoded in this processing for starting unit recording include the service ID and video PID (V_PID). First, the demultiplexer 2 is set to extract the video PID (V_PID) and others (step S1), and the video decoder 3 is set to decode video data carried with the video PID (step S2).

Then a scaling value necessary for video display is given to the scaler 4b, before a video display position and other information are given to the video compositor 5 (steps S3 and S4).

The decoding operation is then started. The record module 7 is set to record the video PID and others therein, the SCD 8 is set to monitor a start code of video data carried with the video PID, and the IDE controller 9 is set to record an output from the record module 7 into the HDD 10 (steps S5 to S8). Then an operation for recording AV stream information is started (step S9).

### (B) Processing for Acquiring Thumbnail

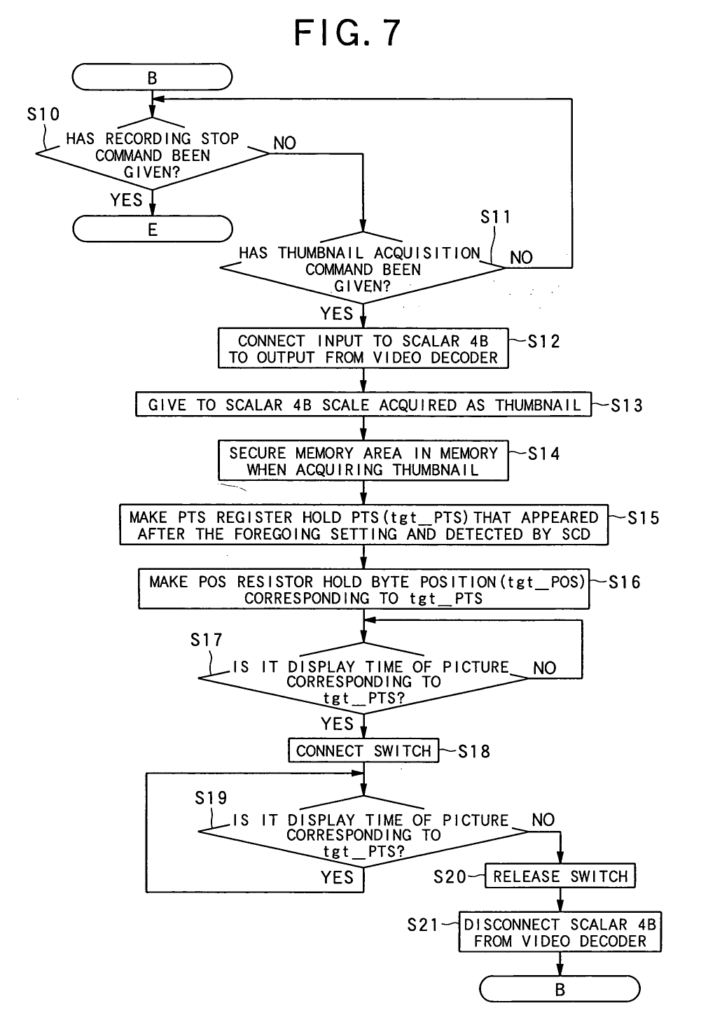

Referring to FIG. 7, the processing for acquiring a thumbnail, which is executed by the CPU 11, will now be explained.

First, it is determined at step S10 whether or not a recording stop command has been given. When there has been given the recording stop command (YES at step S10), the processing is made to proceed to the steps for ending the unit recording, which will be explained later. On the other hand, there has been no such command (NO at step S10), it is further determined at step S11 whether a command for acquiring a thumbnail has been given or not. When the determination shows that there has been given the thumbnail acquisition command (YES at step S11), the processing is shifted to step S12, while it is determined that there is no such command (NO at step S11), the processing is returned to step S10.

At step S12, the input of the scaler 4b is coupled with the output of the video decoder 3, and at step S13, a scaling value required for acquiring a picture as a thumbnail is given to the scaler 4b. The scaling setting processing may be performed in advance by the CPU 11, before the processing for acquiring the thumbnail is carried out.

A memory area required for acquiring the thumbnail is then secured in the memory 6, and a PTS to be targeted (tgt_PTS) that appears after the above setting operation is held by the PTS register 12, such target PTS being detected by the SCD 8 (steps S14 and S15). A byte position (tgt_POS) corresponding to the target PTS (tgt_PTS) is held by the POS register 14 (step S16).

Then, the processing is ordered to wait until a period of time for displaying a video specified by the target PTS (tgt_PTS) comes (step S17). When the display period comes (YES at step S17), the switch 13 is switched on (connected) (step S18). When it is found that the display period for the video specified by the target PTS (tgt_PTS) has elapsed (NO at step S19), the switch 13 is switched off (disconnected), and then a disconnection is made between the scaler 4b and the video decoder 3 (steps S20 and S21).

### (C) Processing for Ending Unit Recording

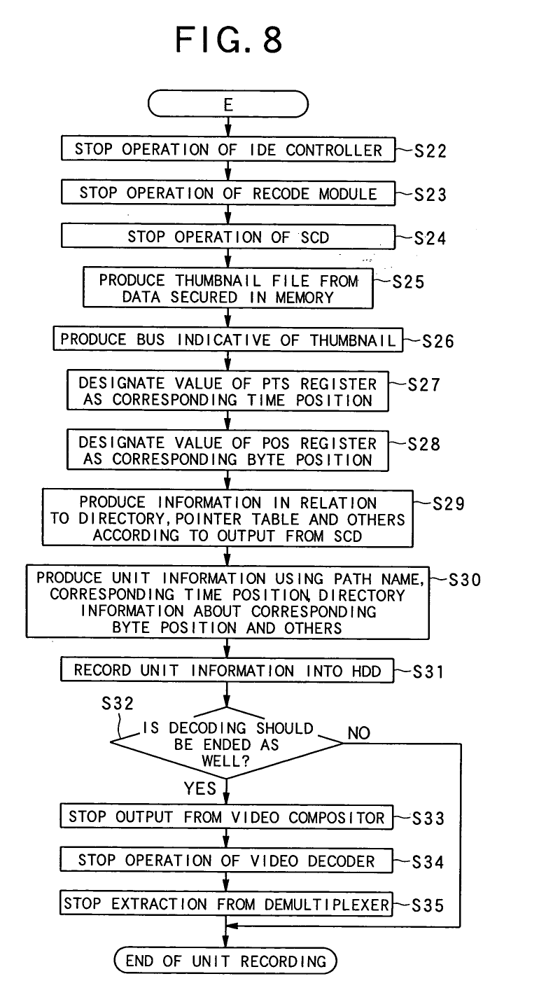

Referring to FIG. 8, the processing for ending the recording operation of the unit information INF, which is executed by the CPU 11, will now be described.

As the first stage, the operations of the IDE controller 9, the recode module 7, and the SCD 8 are stopped in turn (steps S22 to S24).

A thumbnail file is produced from the data secured in the specified area in the memory 6, and then a path that points to the thumbnail is produced (steps S27 and S28). The value of the PTS register 12 is designated as corresponding time position and the value of the POS register 14 is designated as corresponding byte position (steps S27 and S28).

Furthermore, using the outputs from the SCD 8, pieces of information indicative of a directory, pointer table and others are produced, and using thumbnail path name, corresponding time position, corresponding byte position, directory information and others, unit information is produced (steps S29 and S30). The resultant unit information is then recorded in the HDD 10 (step S31).

It is further determined at step S32 if or not the decoding operation should be ended as well. If it is turned out that the processing should be continued (NO at step S32), the processing for ending the unit recording is terminated. On the other hand, when it is determined that the decoding operation should be ended as well (YES at step S32), the video compositor 5 is ordered to stop its output operation, the video decoder 3 is ordered to stop its decoding operation, and the demultiplexer 2 is also commanded to stop the processing for extracting only necessary packets, so that the unit recording operation is terminated entirely (steps S33 to S35).

As described above, in the present embodiment, responsively to an acquisition command for thumbnail information, a PTS is detected by the SCD 8, and the detected PTS is acquired by the CPU 11. The switch 13 is switched by the CPU 11 in a controlled manner so that video signals specified by the acquired PTS and outputted from the scaler 4b are stored into the memory 6. Hence, with viewing a digital broadcasted screen, but without posing the screen, a desired-size thumbnail screen can be made. A user is also able to recognize, during recording a digital broadcasting program, that a screen contributing to the thumbnail screen is located at which position in a recorded bit stream train.

Moreover, in the present embodiment, a video signal outputted from the video decoder 3 is stored in the HDD 10, resulting in that corresponding thumbnail information can be identified easily.

Further, in the present embodiment, the memory 6 is constructed to memorize, as thumbnail information, video data consisting of scaler-outputting data sectioned by the sync signal. Hence a thumbnail image can be acquired in a steadier manner.

For the sake of completeness, it should be mentioned that the various embodiments explained so far are not definitive lists of possible embodiments. The expert will appreciates that it is possible to combine the various construction details or to supplement or modify them by measures known from the prior art without departing from the basic inventive principle.

For example, instead of the foregoing apparatus in which the video signal and other necessary associated signals have been acquired from the BS digital broadcasted signals, another apparatus can be used in which analog ground-wave TV broadcasting, the Internet, or a server VOD (Video On Demand) through a dedicated line is used to provide the video signal and other necessary associated signals.

Further, the HDD 10 which serves as a recording medium in the foregoing embodiment may be replaced by other various types of information recording mediums, such as another information-rewritable DVD and flash memory.

Still further, the programs represented by the flowcharts in FIGS. 6 to 8 may be recoded in information recording mediums such as flexible disk or hard disk. Alternatively, the programs may be downloaded via a network communication line such as the Internet from a server. Such recorded or downloaded programs can be installed into a computer device such as microcomputer system, whereby such computer device is able to provide the same function as that realized by the CPU 11 in the foregoing embodiment.

The entire disclosure of Japanese Patent Application No. 2002-310626 filed on Oct. 25, 2002 including the specification, claims, drawings and summary is incorporated herein by reference in its entirety.

What is claimed is:

1. An apparatus for recording a video signal into a recording medium, the video signal being included in a stream signal, the apparatus comprising:
a detector configured to detect display time information included in the stream signal;
a decoder configured to decode the stream signal to output the video signal;
a scaler configured to change a display scale of the video signal outputted by the decoder in response to a desired size of a thumbnail;
a switch connected to an output of the scaler;
a memory connected via the switch to the scaler;
a display time information acquisition unit configured to acquire the display time information detected by the detector in response to an acquisition command for the thumbnail; and
a controller configured to control a switching operation of the switch so that the video signal outputted from the scaler is stored in the memory, the outputted video signal corresponding to the display time information acquired by the display time information acquisition unit.

2. The apparatus according to claim 1, wherein the memory is configured to memorize the video signal sectioned by a sync signal and outputted from the scaler.

3. A method for recording a video signal into a recording medium, the video signal being included in a stream signal, the method comprising the steps of:
detecting display time information included in the stream signal;
decoding the stream signal to output the video signal;
changing a display scale of the outputted video signal in response to a desired size of a thumbnail;
acquiring the detected display time information in response to an acquisition command for the thumbnail; and
controlling a flow of the video signal of which display scale is changed is stored in a memory, the stored video signal corresponding to the acquired display time information.

4. A computer-readable program for recording a video signal into a recording medium, the video signal being included in a stream signal, the program allowing a computer to monitor and control the steps of:
detecting display time information included in the stream signal;
decoding the stream signal to output the video signal;
changing a display scale of the outputted video signal in response to a desired size of a thumbnail;
acquiring the detected display time information in response to an acquisition command for the thumbnail; and
controlling a flow of the video signal of which display scale is changed is stored in a memory, the stored video signal corresponding to the acquired display time information.
